(19) United States
(12) Patent Application Publication
(10) Pub. No.: US 2023/0174407 A1
(43) Pub. Date: Jun. 8, 2023

(54) METHOD FOR AUTOMATICALLY PROCESSING CONICAL TIP OF OPTICAL FIBER PREFORM

(71) Applicant: JIANGSU ETERN CO., LTD., Suzhou (CN)

(72) Inventors: Yonglin LUO, Suzhou (CN); Longfei WANG, Suzhou (CN); Fan LI, Suzhou (CN); Lihong SUI, Suzhou (CN)

(21) Appl. No.: 17/924,146

(22) PCT Filed: Jul. 20, 2020
(86) PCT No.: PCT/CN2020/102940

§ 371 Date: Nov. 9, 2022

(30) Foreign Application Priority Data
May 14, 2020 (CN) 202010408168.1

(51) Int. Cl. C03B 37/012

(52) U.S. Cl. CPC C03B 37/01251; C03B 37/01257; C03B 37/0126

(57) ABSTRACT

The application provides a method for automatically processing a conical tip of an optical fiber preform, including: step 10: suspending an optical fiber preform requiring conical tip processing on a suspension component, where the optical fiber preform moves downward vertically along with the suspension component; step 20: arranging a furnace body below the suspension component, where a preset depth is set inside the furnace body, and after the optical fiber preform moves to the preset depth inside the furnace body, the furnace body is heated; step 30: arranging an automatic cutting component below the furnace body, where a preset temperature is set inside the furnace body, after a temperature inside the furnace body reaches the preset temperature, a bottom of the furnace body is opened to make the optical fiber preform melt to form a conical tip, and the automatic cutting component cuts the molten conical tip.

### FIELD OF THE INVENTION

The present application relates to the field of optical fiber production and manufacturing, and in particular, to a method for automatically processing a conical tip of an optical fiber preform.

### DESCRIPTION OF THE RELATED ART

After an optical fiber preform has been produced and before drawing is performed, because a target rod is welded at each of two ends in a process of producing the optical fiber preform, the position (that is, a non-conforming optical fiber part) of a target rod welded to a drawing end requires processing before drawing, or otherwise a production loss in drawing increases significantly. Therefore, one working procedure needs to be included. That is, a conical tip of an optical fiber preform is processed. In this working procedure of processing the conical tip, various common methods include an inclined surface tapering method, a heated cutting method in which one target rod is welded, and a high-temperature tip processing method, and the like. The inclined surface tapering method has relatively high processing costs, requires a relatively long time, and tends to cause defects such as an optical fiber deficiency at a front end. In the horizontal heated cutting method, a process of welding a target rod needs to be further added, causing an extra welding cost. In addition, the horizontal cutting processing tends to cause defects in the shape and curvature of a conical tip part. In the vertical high-temperature tip processing method, many companies use manual cutting at present. However, manual cutting causes many disadvantages.

### SUMMARY OF THE INVENTION

A technical problem to be resolved by the present invention is to provide a method for automatically processing a conical tip of an optical fiber preform without relying on manual labor to resolve the deficiencies in an existing technology of processing a conical tip of an optical fiber preform.

The technical solution adopted in the present invention to resolve the technical problem of the present invention is as follows:

A method for automatically processing a conical tip of an optical fiber preform includes the following steps:

step 10: suspending an optical fiber preform requiring conical tip processing on a suspension component, where the optical fiber preform moves downward vertically along with the suspension component;

step 20: arranging a furnace body below the suspension component, where a preset depth is provided inside the furnace body, and after the optical fiber preform moves to the preset depth inside the furnace body, the furnace body is heated;

step 30: arranging an automatic cutting component below the furnace body, where a preset temperature is set inside the furnace body, after a temperature inside the furnace body reaches the preset temperature, a bottom of the furnace body is opened to make the optical fiber preform melt to form a conical tip, and the automatic cutting component cuts the molten conical tip; and

step 40: arranging a collection box below the automatic cutting component, where the cut molten conical tip falls into the collection box.

In an embodiment, the method further includes step 50, including:

after cutting and collection of the molten conical tip are completed, making the suspension component lift the optical fiber preform upward, closing the bottom of the furnace body, and cooling the furnace body.

In an embodiment, the method further includes step 60, including:

after the furnace body is cooled, making the optical fiber preform move upward vertically along with the suspension component to an initial suspension height in step 10, and removing the optical fiber preform.

In an embodiment, step 20 further includes:

arranging a shielding gas valve and an intra-furnace heating body on the furnace body, where after the optical fiber preform moves to the preset depth inside the furnace body, the intra-furnace heating body is turned on, and the shielding gas valve is opened.

In an embodiment, the collection box is a high-temperature resistant scrap glass collection box.

In an embodiment, step 10 further includes:

further connecting an automatic control component to the suspension component, where a reference plane is prestored in the automatic control component, and after the optical fiber preform requiring the conical tip processing is suspended on the suspension component, the optical fiber preform moves downward vertically along with the suspension component to the reference plane.

In an embodiment, step 20 further includes:

prestoring the preset depth in the automatic control component, where the automatic control component is connected to the furnace body and controls heating or cooling of the furnace body.

In an embodiment, step 30 further includes:

prestoring a cutting delay time and a cutting interval time of the automatic cutting component in the automatic control component, where the automatic control component is connected to the automatic cutting component and controls the automatic cutting component to cut the molten conical tip according to the cutting delay time and the cutting interval time.

In an embodiment, step 50 further includes:

further connecting an automatic control component to the suspension component, where a pre-lift height is prestored in the automatic control component, and after the cutting and collection of the molten conical tip are completed, the suspension component lifts the optical fiber preform upward to the pre-lift height, the bottom of the furnace body is closed, and the furnace body is cooled.

In an embodiment, step 60 further includes:

further connecting an automatic control component to the suspension component, where a cooling time is prestored in the automatic control component, and after the furnace body has been cooled for the cooling time, the optical fiber preform moves upward vertically along with the suspension component to the initial suspension height in step 10, and the optical fiber preform is removed.

The beneficial effects of the present invention are as follows: The present invention implements full-process automatic control of preform lowering and temperature increasing in a tapering process and automatic cutting, temperature reduction, and preform lifting in a tipping process without manual intervention, to form adequate control of a conical tip shape and a conical tip weight, thereby improving the quality of optical fibers and reducing costs. In addition, a fully automatic process greatly improves the production efficiency, reduces a manual labor cost, prevents the high temperature of a finished preform from causing physical injuries, and reduces the occurrence of safety accidents.

### BRIEF DESCRIPTION OF THE DRAWINGS

The technical solutions of the present application is described below in detail with reference to the accompanying drawings and the embodiments.

FIG. 1 is a schematic flowchart of a method for automatically processing a conical tip of an optical fiber preform according to an embodiment of the present application; and

FIG. 2 is a schematic structural diagram of a system for automatically processing a conical tip of an optical fiber preform according to an embodiment of the present application.

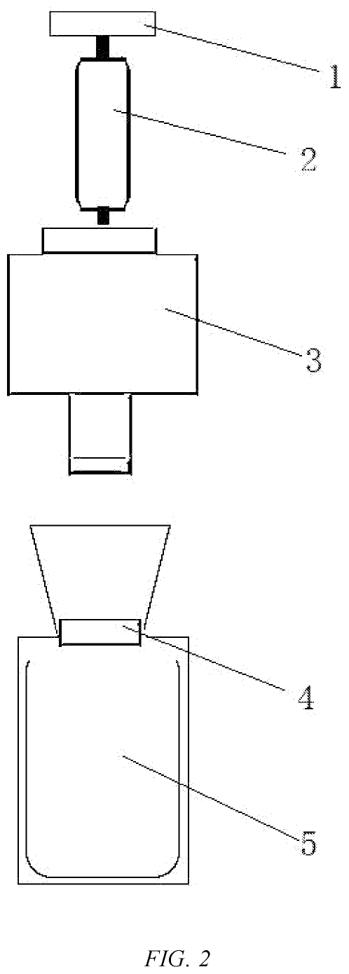

### DETAILED DESCRIPTION OF THE PREFERRED EMBODIMENTS

It needs to be noted that the embodiments in the present application and the features in the embodiments may be combined with each other without causing any conflict.

In the description of the present application, it needs to be understood that orientation or location relationships indicated by terms “center”, “longitudinal”, “transverse” “up”, “down”, “front”, “rear”, “left”, “right”, “vertical”, “horizontal”, “top”, “bottom”, “inside”, and “outside” are based on orientation or location relationships shown in the accompanying drawings, and are only used to facilitate description of the present application and simplify description, but are not used to indicate or imply that the apparatuses or elements must have specific orientations or are constructed and operated by using specific orientations, and therefore, cannot be understood as a limitation to the protection scope of the present application. In addition, the terms “first”, “second”, and the like are only used only for description, but are not intended to indicate or imply relative importance or implicitly indicate the number of technical features indicated. Therefore, features defined by “first”, “second”, and the like may explicitly or implicitly include one or more features. In the description of the present invention, “a plurality of” herein means “two or more” unless otherwise described.

In the description of the present application, it needs to be noted that unless otherwise expressly specified and defined, “mounted”, “connected”, and “connection”, should be understood in a broad sense, for example, fixedly connected, detachably connected or integrally connected; or mechanically connected or electrically connected; or connected directly or indirectly through an intermediate, or two elements communicated internally. For a person of ordinary skill in the art, specific meanings of the terms in the present application should be understood according to specific conditions.

The technical solutions of the present application are described below in detail with reference to the accompanying drawings and in combination with the embodiments.

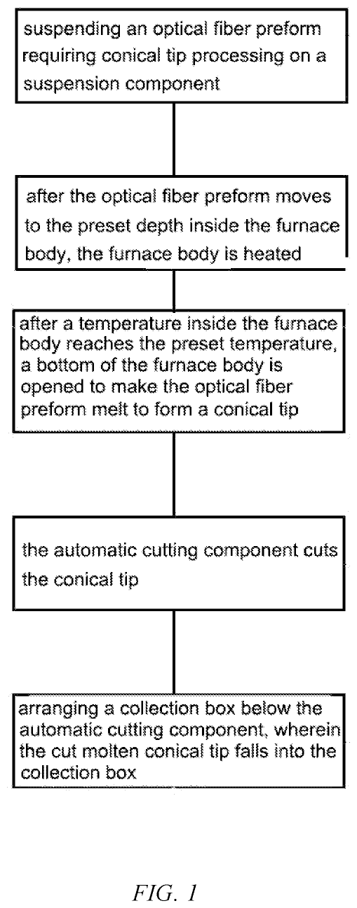

Referring to FIG. 1, a method for automatically processing a conical tip of an optical fiber preform includes the following steps:

Step 10: Suspend an optical fiber preform 2 requiring conical tip processing on a suspension component 1, where the optical fiber preform 2 moves downward vertically along with the suspension component 1.

Step 20: Arrange a furnace body 3 below the suspension component 1, where a preset depth is set inside the furnace body 3, and after the optical fiber preform 2 moves to the preset depth inside the furnace body 3, the furnace body 3 is heated.

Step 30: Arrange an automatic cutting component 4 below the furnace body 3, where a preset temperature is set inside the furnace body 3, after a temperature inside the furnace body 3 reaches the preset temperature, a bottom of the furnace body 3 is opened to make the optical fiber preform 2 melt to form a conical tip, and the automatic cutting component 4 cuts the molten conical tip.

Step 40: Arrange a collection box 5 below the automatic cutting component 4, where the cut molten conical tip falls into the collection box 5.

In an embodiment, the method further includes step 50, including:

after cutting and collection of the molten conical tip are completed, making the suspension component 1 lift the optical fiber preform 2 upward, closing the bottom of the furnace body 3, and cooling the furnace body 3.

In an embodiment, the method further includes step 60, including:

after the furnace body 3 is cooled, making the optical fiber preform 2 move upward vertically along with the suspension component 1 to an initial suspension height in step 10, and removing the optical fiber preform 2.

In an embodiment, step 20 further includes:

arranging a shielding gas valve and an intra-furnace heating body on the furnace body 3, where after the optical fiber preform 2 moves to the preset depth inside the furnace body 3, the intra-furnace heating body is turned on, and the shielding gas valve is opened.

In an embodiment, the collection box 5 is a high-temperature resistant scrap glass collection box 5.

In an embodiment, step 10 further includes:

further connecting an automatic control component to the suspension component 1, where a reference plane is prestored in the automatic control component, and after the optical fiber preform 2 requiring the conical tip processing is suspended on the suspension component 1, the optical fiber preform 2 moves downward vertically along with the suspension component 1 to the reference plane.

In an embodiment, step 20 further includes:

prestoring the preset depth in the automatic control component, where the automatic control component is connected to the furnace body and controls heating or cooling of the furnace body 3.

In an embodiment, step 30 further includes:

prestoring a cutting delay time and a cutting interval time of the automatic cutting component 4 in the automatic control component, where the automatic control component is connected to the automatic cutting component 4 and controls the automatic cutting component to cut the molten conical tip according to the cutting delay time and the cutting interval time.

In an embodiment, step 50 further includes:

further connecting an automatic control component to the suspension component 1, where a pre-lift height is prestored in the automatic control component, and after the cutting and collection of the molten conical tip are completed, the suspension component 1 lifts the optical fiber preform 2 upward to the pre-lift height, the bottom of the furnace body 3 is closed, and the furnace body 3 is cooled.

In an embodiment, step 60 further includes:

further connecting an automatic control component to the suspension component 1, where a cooling time is prestored in the automatic control component, and after the furnace body 3 has been cooled for the cooling time, the optical fiber preform 2 moves upward vertically along with the suspension component 1 to the initial suspension height in step 10, and the optical fiber preform 2 is removed.

Further disclosed in one of the embodiments is a system for automatically processing a conical tip of an optical fiber preform, including a suspension component 1, a furnace body 3, an automatic cutting component 4, a collection box 5, and an automatic control component that are sequentially arranged from top to bottom. The automatic control component is connected to the suspension component 1 and controls the suspension component to move horizontally and vertically, is connected to the furnace body 3 and controls heating and on or off of the furnace body, and is connected to the automatic cutting component 4 and controls a cutting delay and an interval time of the automatic cutting component respectively.

In this embodiment, an applicable diameter range of a processable preform is 50 mm to 180 mm. A conical body taper angle of a region to be processed at a front end of the preform may be controlled within a range of 10° to 80°, and a length of a processed conical tip region ranges from 10 mm to 400 mm. A specific conical tip angle and a specific conical tip length that can be dropped may be completed according to a process formula through control with a programmable logic controller (PLC). Related set parameters are inputted into the process formula: for example, settings of different flow rates for a furnace shielding gas flow rate (idle, temperature increasing, conical tip processing, and cooling) process; settings of time parameters (for example, a temperature increasing time, a temperature reduction time, preform lowering, conical tip processing, a cooling time of approximately 10 min to 50 min, an automatic cutting interval, and a delay time); settings of position information (the preform is lowered to make the origin reach a furnace core position, position lifting after cooling, and the like); settings of temperatures (settings of a standby temperature, a running temperature of 1900° C. to 2100° C., and a temperature increasing step size, and the like); a preform delivery speed of 1 mm/min to 20 mm/min; and settings of a safety limit parameter, and settings of other related parameters. The related parameter and formula settings are loaded into the PLC. The PLC controls the processing of the entire conical tip. The entire control logic is uploaded to the PLC by using a loading process formula. The PLC performs control to complete the entire automatic processing of conical tip.

Further disclosed in one of the embodiments is a procedure of a use scenario of a method for automatically processing a conical tip of an optical fiber preform:

First step: First place an optical fiber preform 2 (referred to as a preform for short) requiring conical tip processing on the suspension component 1, and after the preform is mounted, move the preform downward to reach a reference plane required in the standards.

Second step: Select and load a corresponding process formula, including a series of prestored parameters such as the foregoing cooling time, pre-lift height, cutting delay time, cutting interval time, preset depth, reference plane, preset depth, and preset temperature.

Third step: Click a start button of an automatic control component, for example, an automatic conical tip processing button on a computer or another controller component.

Fourth step: Automatically process a conical tip, including the following steps: First, the optical fiber preform 2 requiring conical tip processing is automatically lowered to a set position of the furnace body 3 according to the loaded formula, and it is automatically started to open an intra-furnace shielding gas valve and turn on an intra-furnace heating body to increase a temperature. After the temperature rises to a designated temperature, according to a lower seal delay switch time of the furnace body set in the formula, in a process of melting and automatic processing of conical tip, a lower sealing apparatus of the furnace body is automatically opened to open a bottom of the furnace body 3. As the automatic processing of conical tip starts, the automatic cutting component 4 performs automatic cutting according to the cutting delay time and the cutting interval time set in the formula. The cut molten conical tip glass falls into a high-temperature resistant scrap glass collection box. In a process of the conical tip processing, the suspension component 1 automatically lowers and lifts the preform in the furnace body according to set parameters in the process. After the conical tip processing is completed, the suspension component 1 lifts the preform with the conical tip processing completed to the set position in the furnace body, and the temperature inside the furnace starts to decrease. The lower sealing apparatus of the furnace body 3 is automatically closed, to prevent oxidation inside the furnace. After the cooling time set in the formula has ended, the suspension component 1 lifts the preform with the conical tip processing completed to the original mounting height before the conical tip processing. At this point, the entire automatic conical tip processing is completed.

Fifth step: An operator removes the preform with the conical tip processing completed.

The beneficial effects of the present invention are as follows: The present invention implements full-process automatic control of preform lowering and temperature increasing in a tapering process and automatic cutting, temperature reduction, and preform lifting in a tipping process without manual intervention, to form adequate control of a conical tip shape and a conical tip weight, thereby improving the quality of optical fibers and reducing costs. In addition, a fully automatic process greatly improves the production efficiency, reduces a manual labor cost, prevents the high temperature of a finished preform from causing physical injuries, and reduces the occurrence of safety accidents.

With the above-mentioned ideal embodiments based on the present application as teachings, it is possible for related workers to make various changes and modifications through the content described above without departing from the scope of the technical idea of the present application. The technical scope of the present application is not limited to the content of the specification, but must be determined by the scope of the claims.

What is claimed is:

1. A method for automatically processing a conical tip of an optical fiber preform, comprising steps of:
step 10: suspending an optical fiber preform requiring conical tip processing on a suspension component, wherein the optical fiber preform moves downward vertically along with the suspension component;
step 20: arranging a furnace body below the suspension component, wherein a preset depth is provided inside the furnace body, and after the optical fiber preform moves to the preset depth inside the furnace body, the furnace body is heated;
step 30: arranging an automatic cutting component below the furnace body, wherein a preset temperature is set inside the furnace body, after a temperature inside the furnace body reaches the preset temperature, a bottom of the furnace body is opened to make the optical fiber preform melt to form a conical tip, and the automatic cutting component cuts the conical tip; and
step 40: arranging a collection box below the automatic cutting component, wherein the cut molten conical tip falls into the collection box.

2. The method for automatically processing a conical tip of an optical fiber preform according to claim 1, further comprising step 50, comprising:
after cutting and collection of the molten conical tip are completed, making the suspension component lift the optical fiber preform upward, closing the bottom of the furnace body, and cooling the furnace body.

3. The method for automatically processing a conical tip of an optical fiber preform according to claim 2, further comprising step 60, comprising:
after the furnace body is cooled, making the optical fiber preform move upward vertically along with the suspension component to an initial suspension height in step 10, and removing the optical fiber preform.

4. The method for automatically processing a conical tip of an optical fiber preform according to claim 1, wherein step 20 further comprises:
arranging a shielding gas valve and an intra-furnace heating body on the furnace body, wherein after the optical fiber preform moves to the preset depth inside the furnace body, the intra-furnace heating body is turned on, and the shielding gas valve is opened.

5. The method for automatically processing a conical tip of an optical fiber preform according to claim 1, wherein the collection box is a high-temperature resistant scrap glass collection box.

6. The method for automatically processing a conical tip of an optical fiber preform according to claim 1, wherein step 10 further comprises:
further connecting an automatic control component to the suspension component, wherein a reference plane is prestored in the automatic control component, and after the optical fiber preform requiring the conical tip processing is suspended on the suspension component, the optical fiber preform moves downward vertically along with the suspension component to the reference plane.

7. The method for automatically processing a conical tip of an optical fiber preform according to claim 6, wherein step 20 further comprises:
prestoring the preset depth in the automatic control component, wherein the automatic control component is connected to the furnace body and controls heating or cooling of the furnace body.

8. The method for automatically processing a conical tip of an optical fiber preform according to claim 6, wherein step 30 further comprises:
prestoring a cutting delay time and a cutting interval time of the automatic cutting component in the automatic control component, wherein the automatic control component is connected to the automatic cutting component and controls the automatic cutting component to cut the molten conical tip according to the cutting delay time and the cutting interval time.

9. The method for automatically processing a conical tip of an optical fiber preform according to claim 2, wherein step 50 further comprises:
further connecting an automatic control component to the suspension component, wherein a pre-lift height is prestored in the automatic control component, and after the cutting and collection of the molten conical tip are completed, the suspension component lifts the optical fiber preform upward to the pre-lift height, the bottom of the furnace body is closed, and the furnace body is cooled.

10. The method for automatically processing a conical tip of an optical fiber preform according to claim 3, wherein step 60 further comprises:
further connecting an automatic control component to the suspension component, wherein a cooling time is prestored in the automatic control component, and after the furnace body is cooled for the cooling time, the optical fiber preform moves upward vertically along with the suspension component to the initial suspension height in step 10, and the optical fiber preform is removed.
